(19) United States
(12) Patent Application Publication
(10) Pub. No.: US 2025/0040559 A1
(43) Pub. Date: Feb. 6, 2025

(54) METHOD FOR PRODUCING TOMATOES HAVING ENHANCED SWEETNESS AND TOMATOES PRODUCED THEREBY

(71) Applicant: WooDeumGeeFarm Co., Ltd., Chungcheongnam-do (KR)

(72) Inventor: Ho Yeon KIM, Chungcheongnam-do (KR)

(73) Assignee: WooDeumGeeFarm Co., Ltd., Chungcheongnam-do (KR)

(21) Appl. No.: 18/717,083

(22) PCT Filed: Sep. 20, 2022
(86) PCT No.: PCT/KR2022/014031

§ 371 Date: Jun. 6, 2024

(30) Foreign Application Priority Data
Jan. 26, 2022 (KR) 10-2022-0011628

(51) Int. Cl. A23B 7/154; A23B 7/015; A23B 7/152; A23L 19/00

(52) U.S. Cl. CPC A23B 7/154; A23B 7/015; A23B 7/152; A23L 19/03

(57) ABSTRACT

The present invention relates to a method for producing tomatoes having enhanced sweetness and tomatoes produced thereby. The manufacturing method of the present invention allows the production of tomatoes with enhanced sweetness while preventing damage to the surface of the tomatoes. In addition, the method of the present invention may reduce taste deterioration over time and improve storability by preventing stevioside injected into the produced tomatoes from leaking out.

### TECHNICAL FIELD

The present invention relates to a method for producing tomatoes having enhanced sweetness and tomatoes produced thereby.

### BACKGROUND ART

Tomatoes refer to a plant or fruit belonging to the Solanaceae family and are known to be native to Latin America. 90% of a tomato fruit is water, and the tomato fruit contains vitamin C which regulates metabolism, vitamin B which helps break down fat, rutin which strengthens capillaries and contributes to improving high blood pressure, amino acids which promote brain activity, iron that is an essential ingredient for hematopoiesis, vitamins A, E, and K, and potassium. Lycopene, an ingredient contained in tomatoes, gives tomatoes the characteristic red color thereof and is reported to have excellent anti-aging and anti-cancer effects.

The tomatoes are low in calories and are often used as a diet food, recently, as the success stories of celebrities and influencers using tomatoes in dieting have been reported through various media, the interest in tomatoes among consumers who want to lose weight is increasing.

However, tomatoes have a sugar content of 4.1 to 5.5 brix, which is somewhat lower than that of other fruits, in addition, some consumers are reluctant to eat tomatoes because of unique taste thereof. Accordingly, research has continued to increase the sweetness of tomatoes to increase consumer preference.

Conventional methods to increase the sweetness of tomatoes include sprinkling sweeteners such as sugar on tomatoes, or using brown sugar, fructose, and saccharose solutions during a cultivation process to increase the sweetness. The methods can provide excellent sweetness by increasing the sugar content of tomatoes, but these methods can increase calories and are not suitable for modern people who are sensitive to calories.

In addition, stevioside is a substance extracted from Stevia, a type of herb, and is one of natural sweeteners known to produce sweetness 300 times higher than sugar, but is not absorbed and excreted from the body.

Conventional methods for injecting stevioside into tomatoes include a method of injecting stevioside using a syringe, and a method of cutting a tomato and injecting stevioside. However, these methods cause damage to the surface of a tomato, reducing marketability and greatly shortening the shelf life.

To solve these problems, methods of penetrating sweeteners into fruit using pressure are also being studied. However, in the method of penetrating sweetener using pressure, when there is a change in pressure, the penetrated substances flow back out of the fruit. As a result, the taste changes over time, and the regurgitated material comes into contact with bacteria in the air, causing spoilage, which shortens the shelf life.

Therefore, it is necessary to develop a technology that can enhance the sweetness of tomatoes by adding substances that can produce sweetness, while preventing the taste of tomatoes from deteriorating over time by preventing the leakage of the injected substances, and extending the shelf life.

### DISCLOSURE

### Technical Problem

The present inventors recognized the problems of the prior art and tried to solve the problems. As a result, when using a specific manufacturing method to enhance the sweetness of tomatoes, leakage of substances penetrated into tomatoes and subsequent decrease in storage properties were improved while enhancing the sweetness of tomatoes. Based on these results, the present inventors completed the present invention.

Therefore, the present invention has been made in view of the above problems, and it is one object of the present invention to provide a method of producing a tomato with enhanced sweetness including the following steps:
step S1 of preparing a solution with a concentration of 0.02 to 0.03% (w/v) by mixing stevioside in water;
step S2 of adding tomatoes to the solution and immersing the tomatoes in the solution;
step S3 (vacuum treatment and pressurization step) of placing the immersed tomatoes in a pressure-adjustable device, maintaining a vacuum of 1×10⁻³ to 1×10⁻² bar for 30 to 90 seconds, injecting compressed air, and then maintaining a pressurized state of 1 to 5 bar for 30 to 90 seconds; and
step S4 of treating the vacuum-treated and pressurized tomatoes with ultrasonic waves.

It is another object of the present invention to provide the method of producing a tomato with enhanced sweetness, wherein step S2 is performed at a temperature of 40 to 50° C. for 5 to 15 minutes.

It is still another object of the present invention to provide the method of producing a tomato with enhanced sweetness, wherein step S3 is repeated 4 to 10 times.

It is still another object of the present invention to provide the method of producing a tomato with enhanced sweetness, wherein step S3 ends with the pressurized state being released.

It is still another object of the present invention to provide the method of producing a tomato with enhanced sweetness, wherein, in step S4, the ultrasonic waves have a frequency of 80 to 130 kHz and an intensity of 400 to 700 W/cm².

It is still another object of the present invention to provide the method of producing a tomato with enhanced sweetness, wherein step S4 is performed at a temperature of 5 to 25° C. for 10 to 50 minutes.

It is still another object of the present invention to provide the method of producing a tomato with enhanced sweetness, wherein the method aims to improve storability.

It is yet another object of the present invention to provide a tomato produced by the method.

### Technical Solution

Hereinafter, the present invention will be described in detail. All combinations of various elements disclosed in the present invention fall into the category of the present invention. In addition, the scope of the present invention is not limited by the specific description below.

In addition, unless otherwise defined within the specification, all terms used in the specification should be understood to have the same meaning as generally understood by a person of ordinary skill in the technical field to which the present invention belongs.

In addition, the expression of singularity in the present specification includes the expression of plurality unless clearly specified otherwise in context.

In addition, “degrees” combined with numbers in this specification refers to degree Celsius (° C.) and may be used interchangeably with “° C.” (For example, “100 degrees” is used interchangeably with “100° C.”).

In accordance with one aspect of the present invention, provided is a method of producing a tomato with enhanced sweetness, the method including:
step S1 of preparing a solution with a concentration of 0.02 to 0.03% (w/v) by mixing stevioside in water;
step S2 of adding tomatoes to the solution and immersing the tomatoes in the solution;
step S3 (vacuum treatment and pressurization step) of placing the immersed tomatoes in a pressure-adjustable device, maintaining a vacuum of 1×10⁻³ to 1×10⁻² bar for 30 to 90 seconds, injecting compressed air, and then maintaining a pressurized state of 1 to 5 bar for 30 to 90 seconds; and
step S4 of treating the vacuum-treated and pressurized tomatoes with ultrasonic waves.

Hereinafter, the method of producing a tomato with enhanced sweetness is described in detail as follows.

In the present invention, step S1 is a step of preparing a solution by mixing stevioside in water.

In step S1, stevioside may be mixed in an amount of 20 to 30 g per 1 L of water, and the solution is preferably prepared to have a concentration of 0.02 to 0.03% (w/v).

When the solution is prepared at a concentration below the range, stevioside may not sufficiently penetrate into the produced tomatoes. When the solution is prepared at a concentration above the range, it may be difficult to control the content of stevioside that penetrates the tomatoes in the next step of this manufacturing method. In this case, it may be undesirable in terms of price competitiveness due to the increase in raw material prices.

In the present invention, step S2 is a step of adding tomatoes to the solution prepared in step S1 and immersing the tomatoes in the solution.

In the present invention, “immersion” means immersing an object in a liquid and leaving the object in the liquid. In the present invention, the immersion may be performed for a specific time in a specific temperature range.

According to embodiments of the present invention, step S2 may be performed at a temperature of 40 to 50° C. for 5 to 15 minutes.

When the above step is performed at a temperature below the range, stevioside may not sufficiently penetrate into the finally produced tomatoes. When the above step is performed at a temperature above the range, the tomatoes may deteriorate, or damage to the tomatoes in the following steps S3 and S4 may increase the defective rate of the tomatoes and reduce production efficiency.

In addition, when the step is performed for a time less than the above range, stevioside may not sufficiently penetrate into the finally produced tomatoes. When the above step is performed for a time above the range, the tomatoes may deteriorate, or damage to the tomatoes in the following steps S3 and S4 may increase the defective rate of the tomatoes and reduce production efficiency.

In the present invention, step S3 is a step in which tomatoes immersed in the solution containing stevioside are placed in the pressure-adjustable device (100) and vacuum treatment and pressurization are performed.

Specifically, in the vacuum treatment and pressurization step, a vacuum treatment process that maintains a vacuum state of 1×10⁻³ to 1×10⁻² bar for 30 to 90 seconds and a pressurization process in which compressed air is introduced and a pressurized state of 1 to 5 bar is maintained for 30 to 90 seconds are repeated.

In the present invention, step S2 of immersing tomatoes in the solution containing stevioside and vacuum treatment and pressurization step S3 are performed separately. In the vacuum treatment and pressurization step, the solution containing stevioside is not additionally applied or sprayed. This method is intended to prevent minor damage to the tomatoes due to additional application or spraying of the solution. Through this method, problems such as taste deterioration and shortened storability (or shelf life) due to leakage of stevioside from the produced tomatoes may be improved.

In step S3, the holding time of each step of the vacuum treatment and pressurization step may be 30 to 90 seconds, preferably 30 to 80 seconds, more preferably 30 to 70 seconds. It is desirable that the holding time of each step is shortened to increase production efficiency, minimize tomato damage, and prevent leakage of the penetrated stevioside.

Step S3 may be performed repeatedly 4 to 10 times, preferably 7 to 10 times.

Repeating step S3 may promote effective penetration of stevioside existing outside the tomatoes and help uniformly distribute stevioside penetrating inside the tomatoes.

When the number of repetitions of S3 is performed below the range, stevioside may not sufficiently penetrate into the tomatoes. When the number of repetitions of S3 is performed beyond the range, the ratio of the penetration amount of stevioside to the number of repetitions may be reduced. In addition, due to the strong sweetener flavor of the finally produced tomatoes, there may be significant differences in consumers' preferences for eating the tomatoes.

Step S3 may end with the pressurized state being released.

That is, in step S3, the vacuum treatment and pressurization steps are repeated as one cycle. At the end of step S3, the last pressurized state is released and terminated. That is, step S3 of the present invention does not release from the vacuum step.

It was specifically confirmed that the effect of preventing leakage of stevioside injected into tomatoes may be significantly improved when released from the pressurized state compared to when released from the vacuum state.

According to one embodiment of the present invention, a schematic drawing of a pressure-adjustable device (100) for performing step S3 of the present invention is shown in FIG. 1. As the pressure-adjustable device (100), a device including a part for maintaining a vacuum state, a part for maintaining a pressurized state by supplying compressed air, and a part for measuring the pressure of an internal space may be used without particular limitation.

More specifically, the part for maintaining a vacuum state may include a vacuum pump 2 and a compressed air discharge regulator 21.

In addition, the part for maintaining a pressurized state may include a compressed air reservoir 1 and a compressed air supply regulator 20.

In addition, the part for measuring the pressure of an internal space may include a pressure measuring device 10 equipped with a dial.

In addition, the internal space of the pressure-adjustable device (100) may have a capacity of 10 to 500 L, preferably 150 to 300 L.

In addition, it may be advantageous to maintain a temperature range of 25 to 30° C. inside the pressure-adjustable device (100) to maintain the freshness of tomatoes.

In the present invention, step S4 is a step in which the tomatoes that have been subjected to the vacuum treatment and pressurization step are treated with ultrasonic waves using a device (200) equipped with an ultrasonic generator. The above step serves to prevent reflux of stevioside that has penetrated into a tomato by rapidly diffusing the stevioside inside the tomato.

Conventional techniques using vacuum and pressurization show that stevioside injected into a certain part of a tomato tends to spread throughout the tomato through the osmosis process only after a certain period of time has elapsed. In this case, there was a problem that the stevioside injected into the tomato flowed back due to pressure changes.

According to experimental examples described later, the manufacturing method of the present invention involves vacuum and pressurization, and the reflux phenomenon of stevioside penetrating inside may be prevented in tomatoes produced through the manufacturing method. Accordingly, it was specifically proven that the method of the present invention may improve the problems of the conventional manufacturing method.

These results, without being bound by a specific theory, indicate that cavitation caused by ultrasonic waves widens the gap between cell tissues and speeds up the movement and diffusion of stevioside, preventing the backflow of stevioside that has penetrated into the tomato.

In step S4, the ultrasonic waves may have a frequency of 80 to 130 kHz and an intensity of 400 to 700 W/cm². According to embodiments of the present invention, the ultrasonic waves may have a frequency of 100 kHz and an intensity of 500 W/cm², without being limited thereto.

When the ultrasonic waves have a frequency below the above range, the cleaning effect due to the ultrasonic waves may appear, but the intended effects of the present invention due to the ultrasonic waves, i.e., the effect of preventing taste deterioration over time and improving storability by preventing the outflow of stevioside, may not appear. When the ultrasonic waves have a frequency above the above range, the ultrasonic waves may damage tomatoes and increase the defect rate.

In addition, when the ultrasonic waves have an intensity below the above range, the intended effects of the present invention due to the ultrasonic waves, i.e., the effect of preventing taste deterioration over time and improving storability by preventing the outflow of stevioside, may not appear. When the ultrasonic waves have an intensity above the above range, the ultrasonic waves may damage tomatoes and increase the defect rate.

Step S4 may be performed at a temperature of 5 to 25° C. for 10 to 50 minutes, preferably 20 to 40 minutes.

To ensure the freshness of the final produced tomatoes, step S4 is preferably performed in the temperature range.

In addition, when step S4 is performed for a time less than the above range, the intended effects of the present invention due to the ultrasonic waves may not appear. When step S4 is performed for a time exceeding the above range, the ultrasonic waves may damage tomatoes and increase the defect rate.

According to one embodiment of the present invention, a schematic drawing of the device (200) equipped with an ultrasonic generator to perform step S4 of the present invention is shown in FIG. 2. As the device equipped with an ultrasonic generator, a device including a container for containing tomatoes, an ultrasonic generator connected thereto, and a temperature control part may be used without particular limitation.

A container (220) for containing tomatoes may have a capacity of 10 to 500 L, preferably 150 to 300 L.

In addition, the ultrasonic generator may include an ultrasonic generator (210), and the ultrasonic generator may generate ultrasonic waves having a frequency of 80 to 130 kHz and an intensity of 400 to 700 W/cm².

In addition, the temperature control part may include a cooler (230), a temperature sensor (240), and a controller (250). The temperature sensor (240) is connected to the container (220) and the controller (250) and measures the temperature inside the container and transmits the temperature information to the controller (250). The controller (250) analyzes the received temperature information and controls the ultrasonic generator (210) and the cooler (230) connected thereto to maintain the temperature inside the container at a desired temperature.

According to embodiments of the present invention, the tomatoes with enhanced sweetness produced by the method may have an electrical conductivity (EC) of 153 to 205 μs/cm, preferably 153 to 170 μs/cm as measured using an EC water quality concentration meter (manufacturer: Lightcom Co., Ltd., model name: HD416), without being limited thereto.

As the concentration of the tomatoes increases, electrical conductivity decreases. This is due to the penetration of stevioside into the tomatoes, increasing the internal concentration. In the Experimental Example described later, the electrical conductivity of the tomatoes with enhanced sweetness produced through the manufacturing method of the present invention was confirmed to be low, proving that the manufacturing method of the present invention may be usefully used to enhance the sweetness of tomatoes. In addition, it was confirmed that the change in electrical conductivity of tomatoes produced through the manufacturing method of the present invention was minimal over time, and it was specifically proven that the leakage of stevioside penetrated inside was insignificant.

The manufacturing method of the present invention aims to improve the storability of the tomatoes with enhanced sweetness.

In the present invention, the storability is that when left at room temperature, the total number of bacteria does not exceed 10⁶ CFU/g for more than 10 days, preferably 10 days to 30 days, more preferably 10 days to 20 days, still more preferably 10 days to 14 days, and the total bacterial count on the last day of the range may be in the range of 10 to 10⁶ CFU/g, preferably 10⁴ to 10⁵ CFU/g, more preferably 10³ to 10⁴ CFU/g, without being limited thereto.

In the case of fruits injected with sweetener according to the conventional method, there was a problem that the shelf life was short. However, in the case of the tomatoes produced through the manufacturing method of the present invention, since the outflow of stevioside that has penetrated into the tomatoes may be prevented as much as possible, the deterioration of taste over time may be minimal and storability may also be increased.

In accordance with another aspect of the present invention, provided is a tomato produced by the method of producing a tomato with enhanced sweetness.

In this specification, unless otherwise stated, tomato with enhanced sweetness is the same as described in the manufacturing method, and the description thereof is omitted to avoid excessive repetition of the same content in the specification.

### Advantageous Effects

The manufacturing method of the present invention has excellent marketability because the method allows the production of tomatoes with enhanced sweetness while preventing damage to the surface of the tomatoes.

In addition, since the manufacturing method of the present invention can improve the problem of the conventional method of injecting stevioside into tomatoes, that is, the leakage of the injected stevioside, the method of the present invention can reduce taste deterioration over time and has the effect of increasing storability.

In addition, the sweetness of tomatoes produced using the manufacturing method of the present invention can be enhanced without increasing the calories of the tomatoes. Accordingly, the tomatoes according to the present invention can be beneficial to health and can be especially useful for consumers who need to lose weight.

### DESCRIPTION OF DRAWINGS

FIG. 1 shows a schematic drawing of a pressure-adjustable device (100) used in the manufacturing method of the present invention, as an embodiment.

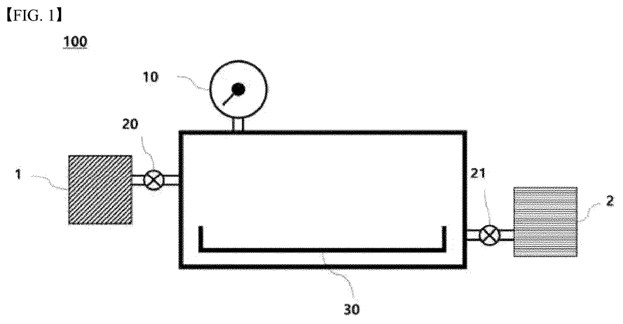

FIG. 2 shows a schematic drawing of a device (200) equipped with an ultrasonic generator used in the manufacturing method of the present invention, as an embodiment.

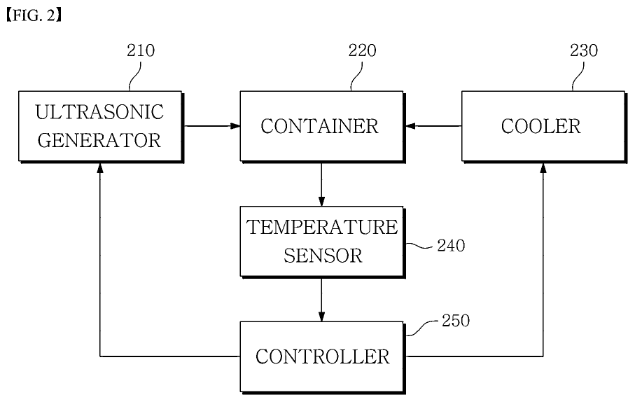

FIG. 3 is a graph showing the results of confirming through electrical conductivity whether the manufacturing method of the present invention enhances the sweetness of tomatoes.

FIG. 4 shows the results of confirming through electrical conductivity whether the manufacturing method of the present invention may solve the problem of leakage of stevioside injected into tomatoes, which is a problem with conventional technologies.

FIG. 5 shows the results of measuring microbial changes according to the storage period of tomatoes produced by the manufacturing method of the present invention.

### BEST MODE

Hereinafter, the present invention is explained in more detail by examples. However, these examples are intended to illustrate the present invention, and the scope of the present invention is not limited by these examples. In addition, terms not specifically defined in this specification should be understood to have meanings commonly used in the technical field to which the present invention belongs.

### EXAMPLE

First, 20 to 30 g of stevioside per 1 L of water was mixed, and the mixture was stirred while heated to a temperature of about 45° C. to prepare a solution containing stevioside. Next, tomatoes were placed in the solution so that the tomatoes were completely submerged, and immersed for 10 minutes while maintaining the temperature at about 45° C.

Next, the tomatoes were taken out and placed in the pressure-adjustable device (100), and the vacuum treatment and pressurization step was performed. Specifically, in the vacuum treatment and pressurization step, a cycle of maintaining a vacuum state at a pressure of 1×10⁻³ to 1×10⁻² bar for about 1 minute, introducing compressed air, and then maintaining a pressurized state at a pressure of 1 to 5 bar for about 1 minute is repeated 1 to 10 times. After the last cycle, it is released from the pressurization state.

Next, the tomatoes were removed from the device and placed in the device (200) equipped with an ultrasonic generator, and ultrasonic waves were applied thereto. Specifically, purified water was filled into the container loaded with the tomatoes, and then ultrasonic waves (100 kHz, 500 W/cm²) were applied for about 30 minutes while maintaining the temperature at 20° C. Then, the tomatoes were taken out to prepare the tomatoes of the example.

### Comparative Example 1

Tomatoes were produced in the same manner as in Example, except that the ultrasonication step was omitted.

Specifically, 20 to 30 g of stevioside per 1 L of water was mixed, and the mixture was stirred while heated to a temperature of about 45° C. to prepare a solution containing stevioside. Next, tomatoes were placed in the solution so that the tomatoes were completely submerged, and immersed for 10 minutes while maintaining the temperature at about 45° C.

Next, the tomatoes were taken out and placed in the pressure-adjustable device (100), and the vacuum treatment and pressurization step was performed.

Next, the tomatoes were taken out from the device and the tomatoes of Comparative Example 1 were prepared.

### Comparative Example 2

Tomatoes were produced in the same manner as in Example, except that ultrasonic waves having a frequency of 40 kHz and an intensity of 500 W/cm² were used in the ultrasonication step.

Specifically, 20 to 30 g of stevioside per 1 L of water was mixed, and the mixture was stirred while heated to a temperature of about 45° C. to prepare a solution containing stevioside. Next, tomatoes were placed in the solution so that the tomatoes were completely submerged, and immersed for 10 minutes while maintaining the temperature at about 45° C.

Next, the tomatoes were taken out and placed in the pressure-adjustable device (100), and the vacuum treatment and pressurization step was performed.

Next, the tomatoes were removed from the device and placed in the device (200) equipped with an ultrasonic generator, and ultrasonic waves were applied thereto. Specifically, purified water was filled into the container loaded with the tomatoes, and then ultrasonic waves (40 kHz, 500 W/cm²) were applied for about 30 minutes while maintaining the temperature at 20° C. Then, the tomatoes were taken out to prepare the tomatoes of Comparative Example 2.

### Comparative Example 3

Tomatoes were produced in the same manner as in Example, except that ultrasonic waves having a frequency of 100 kHz and an intensity of 800 W/cm² were used in the ultrasonication step.

Specifically, 20 to 30 g of stevioside per 1 L of water was mixed, and the mixture was stirred while heated to a temperature of about 45° C. to prepare a solution containing stevioside. Next, tomatoes were placed in the solution so that the tomatoes were completely submerged, and immersed for 10 minutes while maintaining the temperature at about 45° C.

Next, the tomatoes were taken out and placed in the pressure-adjustable device (100), and the vacuum treatment and pressurization step was performed.

Next, the tomatoes were removed from the device and placed in the device (200) equipped with an ultrasonic generator, and ultrasonic waves were applied thereto. Specifically, purified water was filled into the container loaded with the tomatoes, and then ultrasonic waves (100 kHz, 800 W/cm²) were applied for about 30 minutes while maintaining the temperature at 20° C. Then, the tomatoes were taken out to prepare the tomatoes of Comparative Example 3.

### Comparative Example 4

Tomatoes were produced in the same manner as in Example, except that ultrasonic waves were applied for 1 hour in the ultrasonication step.

Specifically, 20 to 30 g of stevioside per 1 L of water was mixed, and the mixture was stirred while heated to a temperature of about 45° C. to prepare a solution containing stevioside. Next, tomatoes were placed in the solution so that the tomatoes were completely submerged, and immersed for 10 minutes while maintaining the temperature at about 45° C.

Next, the tomatoes were taken out and placed in the pressure-adjustable device (100), and the vacuum treatment and pressurization step was performed.

Next, the tomatoes were removed from the device and placed in the device (200) equipped with an ultrasonic generator, and ultrasonic waves were applied thereto. Specifically, purified water was filled into the container loaded with the tomatoes, and then ultrasonic waves (100 kHz, 500 W/cm²) were applied for about 1 hour while maintaining the temperature at 20° C. Then, the tomatoes were taken out to prepare the tomatoes of Comparative Example 4.

### Experimental Example 1. Confirmation of Sweetness Enhancement Effect

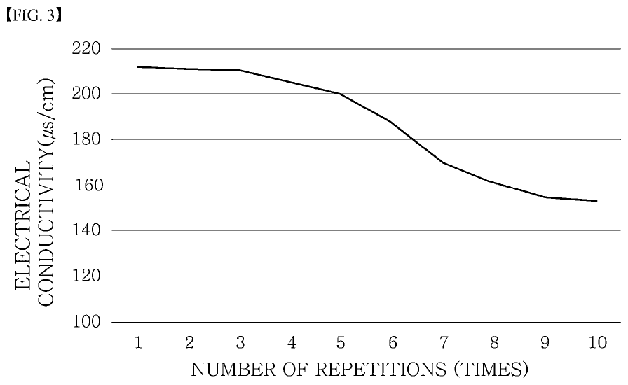

To evaluate the sweetness enhancement effect, the electrical conductivity (EC) of the tomatoes of Example produced by repeating the vacuum treatment and pressurization step 1 to 10 times was measured using an EC water quality concentration meter (manufacturer: Lightcom Co., Ltd., model name: HD416), and the results are shown in FIG. 3.

As shown in FIG. 3, it can be seen that the electrical conductivity decreases when the vacuum treatment and pressurization step is performed more than 4 times. These results indicate that stevioside penetrated into the tomatoes and that the concentration of stevioside increased within the tomatoes.

In particular, it can be seen that the electrical conductivity decreases as the number of repetitions of the vacuum treatment and pressurization step increases.

These results indicate that sweetness may be adjusted simply by repeating the step. Accordingly, it was confirmed that step-by-step products that may satisfy the diverse tastes of consumers may be produced.

### Experimental Example 2. Confirmation of Stevioside Leak Prevention Effect

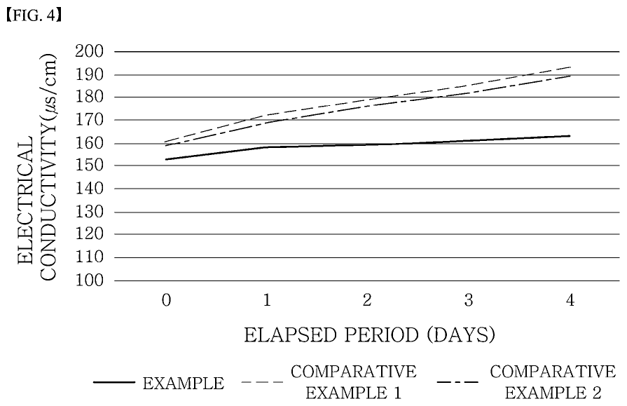

To evaluate the effectiveness of preventing the injected sweetener from leaking out, changes in the electrical conductivity (EC) of the tomatoes of Example and Comparative Examples produced by repeating the vacuum treatment and pressurization step 10 times were measured using an EC water quality concentration meter (manufacturer: Lightcom Co., Ltd., model name: HD416) for 4 days, and the results are shown in FIG. 4.

As shown in FIG. 4, compared to the tomatoes of Example produced according to the manufacturing method of the present invention, the electrical conductivity of the tomatoes of Comparative Examples 1 and 2 significantly increases over time.

These results show that the manufacturing method of the present invention may overcome the disadvantages of the conventional method of improving the sweetness of tomatoes by injecting stevioside into tomatoes using pressure, i.e., problems such as taste deterioration over time and shortened shelf life due to pressure changes causing stevioside to flow back and come out of fruits and vegetables.

### Experimental Example 3. Confirmation of Defect Rate According to Ultrasonic Conditions

For the 50 tomatoes produced in Example and Comparative Examples, the defect rates according to ultrasonic conditions were analyzed by visually checking whether the tomatoes were damaged, and the results are shown in Table 1.

$$[ Equation ]$$

$$Defect rate ( \% ) = ( Number of damanged tomatoes / Number of intact tomatoes ) \times 100$$

TABLE 1

| | Defect rate (%) |
|---|---|
| Example | 6 |
| Comparative Example 3 | 30 |
| Comparative Example 4 | 24 |

As shown in Table 1, it can be confirmed that, when some changes are made to the conditions during the ultrasonic treatment step, the defect rate of the produced tomatoes may increase. In addition, it is confirmed that ultrasonic waves under certain conditions may be useful in terms of manufacturing efficiency.

### Experimental Example 4. Confirmation of Storability

The storability of tomatoes with enhanced sweetness produced according to the manufacturing method of the present invention was confirmed by measuring microbial changes depending on the storage period.

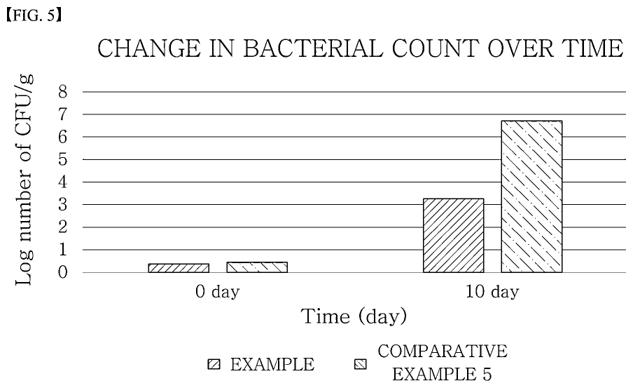

Specifically, after the tomatoes produced according to Example and Comparative Example 5 (produced according to the method of No. 10-2019-0052055) were left at room temperature for 10 days, 5 g of the tomatoes was placed in a filter pack, 100 ml of purified water was added thereto, and the mixture was homogenized using a homogenizer. Next, 1 ml of the homogenized liquid was collected, added to 9 ml of a saline solution, and cultured in medium (Difco Lab, USA) for 24 hours (37° C.). Then, the number of bacteria was measured, and the results are shown in FIG. 5.

As shown in FIG. 5, in the case of the prior art, the injected substances flow back and flow out of fruits and vegetables, and the refluxed substances meet microscopic bacteria and various aerobic and basic bacteria in the air, causing spoilage. However, in the case of the manufacturing method of the present invention, the shelf life of fruits injected with stevioside may be increased by preventing leakage of the injected stevioside.

### DESCRIPTION OF SYMBOLS

100: Pressure-Adjustable Device
1: Compressed Air Reservoir
2: Vacuum Pump
10: Pressure Measuring Device
20: Compressed Air Supply Regulator
21: Compressed Air Discharge Regulator
30: Internal Container
200: Device Equipped with Ultrasonic Generator
210: Ultrasonic Generator
220: Container
230: Cooler
240: Temperature Sensor
250: Controller

1. A method of producing a tomato with enhanced sweetness, comprising:
step S1 of preparing a solution with a concentration of 0.02 to 0.03% (w/v) by mixing stevioside in water;
step S2 of adding tomatoes to the solution and immersing the tomatoes in the solution;
step S3 (vacuum treatment and pressurization step) of placing the immersed tomatoes in a pressure-adjustable device, maintaining a vacuum of 1×10⁻³ to 1×10⁻² bar for 30 to 90 seconds, injecting compressed air, and then maintaining a pressurized state of 1 to 5 bar for 30 to 90 seconds; and
step S4 of treating the vacuum-treated and pressurized tomatoes with ultrasonic waves.

2. The method according to claim 1, wherein step S2 is performed at a temperature of 40 to 50° C. for 5 to 15 minutes.

3. The method according to claim 1, wherein step S3 is repeated 4 to 10 times.

4. The method according to claim 1, wherein step S3 ends with the pressurized state being released.

5. The method according to claim 1, wherein, in step S4, the ultrasonic waves have a frequency of 80 to 130 kHz and an intensity of 400 to 700 W/cm2.

6. The method according to claim 1, wherein step S4 is performed a temperature of 5 to 25° C. for 10 to 50 minutes.

7. The method according to claim 1, wherein the method aims to improve storability.

8. A tomato produced by the method according to claim 1.

9. A tomato produced by the method according to claim 2.

10. A tomato produced by the method according to claim 3.

11. A tomato produced by the method according to claim 4.

12. A tomato produced by the method according to claim 5.

13. A tomato produced by the method according to claim 6.

14. A tomato produced by the method according to claim 7.
